(19) United States
(12) Patent Application Publication
(10) Pub. No.: US 2021/0269329 A1
(43) Pub. Date: Sep. 2, 2021

(54) Geothermal based water desalination system with multiple tanks

(71) Applicant: Mirza Faizan, (US)

(72) Inventors: Mirza Faizan, Irving, TX (US); Mohammad Ayaan, Plano, TX (US); Mariya Kawish, Plano, TX (US); Faizaan Syed Hussain, Plano, TX (US); Maryam Abid Bhojwani, Plano, TX (US); Bilal Syed Ali Shah, Murphy, TX (US); Nimra Syeda Ali Shah, Murphy, TX (US)

(21) Appl. No.: 17/185,003

(22) Filed: Feb. 25, 2021

Related U.S. Application Data
(60) Provisional application No. 62/982,749, filed on Feb. 27, 2020.

(51) Int. Cl. C02F 1/04; B01D 1/00; B01D 1/30; B01D 5/00; F24T 50/00

(52) U.S. Cl. CPC C02F 1/043; B01D 1/0029; B01D 1/0064; C02F 2103/08; B01D 5/0054; B01D 5/006; F24T 50/00; B01D 1/30

(57) ABSTRACT

The water desalination system using geothermal energy includes a plurality of heat transfer rods. Desalinated water flows into the injector and reaches the evaporation chamber, wherein the evaporation chamber receives heat geothermally via a plurality of heat transfer rods 18. Further, the heat transfer rods 18 heat the water in the evaporation chamber, which results in the formation of steam. The steam is carried to one or more storage tanks by means of one or more pipes. The steam generated from the evaporation chamber on reaching the storage tanks get condensed and water is formed.

### TECHNICAL FIELD

This invention relates generally to the desalination of seawater and the production of freshwater. The present invention more specifically relates to desalinate water using geothermal heat.

### BACKGROUND OF THE INVENTION

Desalination is a growing industry in many parts of the world. Not only the countries with vast areas of and lands, but the developed and the developing countries also are increasingly producing freshwater by desalination to meet the demands of the growing population and rising standards of living.

The necessity of water for sustaining life, combined with the limited supply of usable water, make water a valuable resource or commodity in numerous parts of the world. Many areas of the world have been repeatedly plagued with droughts leading to famine and disease. The lack of water, or the use of poor-quality water, causes or transmits diseases such as malaria, cholera, diarrhea, typhoid, hepatitis, dysentery, etc. Even in prosperous agricultural areas, water rights and shares cause contentions, strife, and litigation. Despite its essential nature, freshwater appears to be a declining resource. Two factors contributing to the decreasing water supply include population growth and global warming. As the population grows, less water is available per person from existing water sources. Global warming refers to the probability that the earth is subject to hotter temperatures, due at least in part to the growing use of fossil fuels which produce global warming gases. Climatologists have asserted that the consequences of higher temperatures will include hotter summers, irregular weather patterns, reservoir evaporation, and agricultural stress.

Another factor contributing to the lack of freshwater includes industrial pollution of water systems. Therefore, increased population, global warming/climate changes, and pollution are combining to reduce the amount of water available per person. With a growing population and limited water supply, the shortage gap will continue to increase. Water conservation will undoubtedly remain an important factor. With the ever-rising human population and growing cities, the demand for pure water has increased manifold. Humans have exploited groundwater to the extent that we have already depleted the groundwater reserve in many big cities in the world. Water is a necessity for human life and in this scenario, we have to depend on seawater for survival which is available in abundance. The problem with seawater is, it is highly saline, meaning the salt content is so high that humans cannot consume it.

Desalination involves the removal of salt, or brine, from saltwater to produce potable, or drinkable, water. Desalination is attractive due to its potential to convert the largest source of water, the ocean, into usable water. Desalination appears particularly promising for many cities with coastal locations. Despite its promise and potential, however, desalination has failed to emerge as a prevailing solution or source of freshwater.

There are ways to desalinate seawater for human consumption, which are either very slow as they depend on the sun to evaporate desalinated water or they are highly energy consuming as they require a huge amount of energy to evaporate water artificially other desalination proposals include microbial, solar, hydrogen, and even nuclear fusion. Microbial desalting refers to eliminating sodium in seawater similar to a bacterium altering sodium ions during respiration. Solar desalting refers to the use of either solar panels or solar cells to desalt water. Hydrogen desalting refers to the process of using hydrogen n water as a power source to desalt water. Nuclear fusion desalting refers to a potentially benign process that uses the latent power of the atom. Water has a very high specific heat capacity thus it requires a lot of energy to heat the water. This is a highly inefficient method to desalinate the water. In light of this scenario, there was a need for a system that can desalinate water without using energy and in large quantity.

Therefore, it would be advantageous to develop a system and method to produce potable water from brine or another water source. Also, it would be advantageous to develop such a system and method to produce potable water while conserving energy. Also, it would be advantageous to develop such a system and method to produce potable water while conserving natural resources, such as fossil fuels, land, minerals, water, etc.

To optimize the geothermal energy production, various developments have been made.

For example, EP 2 189 731 A1 shows such a geothermal probe. The apparatus comprises a downwardly directed conveyor tube that leads into a container in the ground and an upwardly directed conveyor tube, wherein the device may be operated by the natural circulation or by a pump. Further other prior art, DE 30 29 900 A1 relates to a heat exchanger for the use of geothermal energy, with an introduced in a borehole boiler, which is thermostatically controlled by a valve or filled according to the lint principle. The boiler is filled via a downpipe, while the forming steam is discharged upwards via an insulated riser pipe.

All of these conventional methods/systems, and some other methods/systems presently known in the art have had some flaws in design or mechanism and lacks precision. Most of the existing devices are too expensive and time consuming to be practical for most users. Some shortfalls of the existing method/system known devices for the production of geothermal energy have the disadvantage that they have too low efficiency respectively generate too low heat output respectively electrical power. In light of this, there is a need for a method/system that overcomes these constraints.

All conventionally used distillation systems and devices require external energy resources for their operation. In many cases, solar energy is used. Alternatively, many systems have been constructed to use energy input from other sources, e.g., heating by burning petroleum fuels, the electrical energy produced by the burning of such fuels or other fossil fuels, etc. Such energy-intensive systems are generally capable of producing a considerably greater volume of pure water than systems utilizing only solar energy, but the cost of water production is relatively high due to the cost of the energy used.

Further, there is also a need fora seawater desalination system, wherein seawater is sent down a pipe to a depth sufficient to heat the water to over one hundred degrees Celsius and then returned to a vaporizing and condensing system at the surface.

None of the above inventions and patents, taken either singly or in combination, is seen to describe the present invention as claimed. Thus, a water desalination system using geothermal energy to solve the aforementioned problems is desired.

Features and advantages of the invention will be set forth in the description that follows, and in part will be apparent from the description, or may be learned by practice of the invention. The advantages of the invention will be realized and attained by the structure particularly pointed out in the written description and claim hereof as well as the appended drawings.

It is to be understood that both the foregoing general description and the following detailed description are exemplary and explanatory and are intended to provide further explanation of the invention as claimed.

The present invention addresses the issues discussed above.

### SUMMARY OF THE INVENTION

It is an object of the present invention to provide a system and method for purifying water. The present invention provides a cost-effective continuous Deepwater desalination method. The present invention deepwater desalination system, wherein the system uses heat transfer roads and uses the heat generated from earth to raise the desalinized water through an evaporation chamber into a series of tanks via pipes. The water desalination system using geothermal energy includes a plurality of heat transfer rods for the saltwater to be distilled.

According to the present invention, Saltwater is piped into an injector pipe, and the saltwater moves into an evaporation chamber whereupon heated by transfer road using geothermal energy. Evaporated moisture from the chamber condenses upon the tanks present outside of the surface. The evaporative process is attained by energy input from heat transfer road, by geothermal heating. The heated water gets converted into steam then rises to the steam transfer pipe where steam circulates storage tanks and condenses to form water.

According to an object of the present invention, the deepwater desalination system can have an evaporation chamber configured to be held below water and fixed at a depth from the surface where evaporation can occur geothermally and produces more heat in contact with the heat transfer rods.

However, it is clear to the person skilled in the art that the heat transfer rods can be operationally suitable even at shallower depths. This depends not least on the desired performance of the heat transfer rods. Thus, a drilling depth of 5 to 7 km or even between 1 and 5 km may be sufficient. If heat transfer rods are used for example in a volcanic area, the drilling depth can also be much lower. On the other hand, the drilling depth can be greater than 7 km.

According to another object of the present invention, the system involves several series tanks connected outside through the steam transfer pipe.

According to another object of the present invention, the system involves a filter system the injector pipe, wherein the filter is used to filter the seawater and to avoid entry of fishes, their eggs garbage, etc to the evaporation chamber through the injector pipe.

According to another object of the present invention, the system involves a pressure system in storage tanks to creates high pressure, wherein the high pressure by the pressure system forces a leftover brine solution to travel through a brine collection pipe and get deposited in a brine collection tank, from the brine collection tank, the leftover brine solution is treated and discharged back to the sea.

According to another object of the present invention, the system involves one or more brine collector tanks that store the leftover brine solution after passing through heat processes.

Further, the system also comprises a sensor system that automatically/manually tells the user about the filling of the brine solution in the collector tank to vacate it again for further processes.

Other features can include a series of tanks connected with the evaporation chamber via pipes. The valves being configured automatically or manually to selectively allow the steam to pass to series of tanks or flow the water to the evaporation chamber or the brine collector tank and from the series of tanks to the outer world.

Other objects, advantages, and features of this invention will become more apparent from the following description.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts a certain illustrative embodiment of the invention. This depicted embodiment is to be understood as illustrative of the invention and not as limiting in any way.

Referring particularly to the drawing for illustration only and not limitation, there is illustrated:

FIG. 1 shows an overall view of geothermal based water desalination as according to an embodiment of the present invention.

FIG. 2 shows the series tank mechanism of a water desalination system using geothermal energy according to an embodiment of the present invention.

FIG. 3 shows the flow diagram of a water desalination system using geothermal energy according to the present invention.

### DETAILED DESCRIPTION OF THE DRAWINGS

Refer now to the drawings wherein depicted elements are not necessarily shown to scale and wherein like or similar elements are designated by the same reference numeral through the several views.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

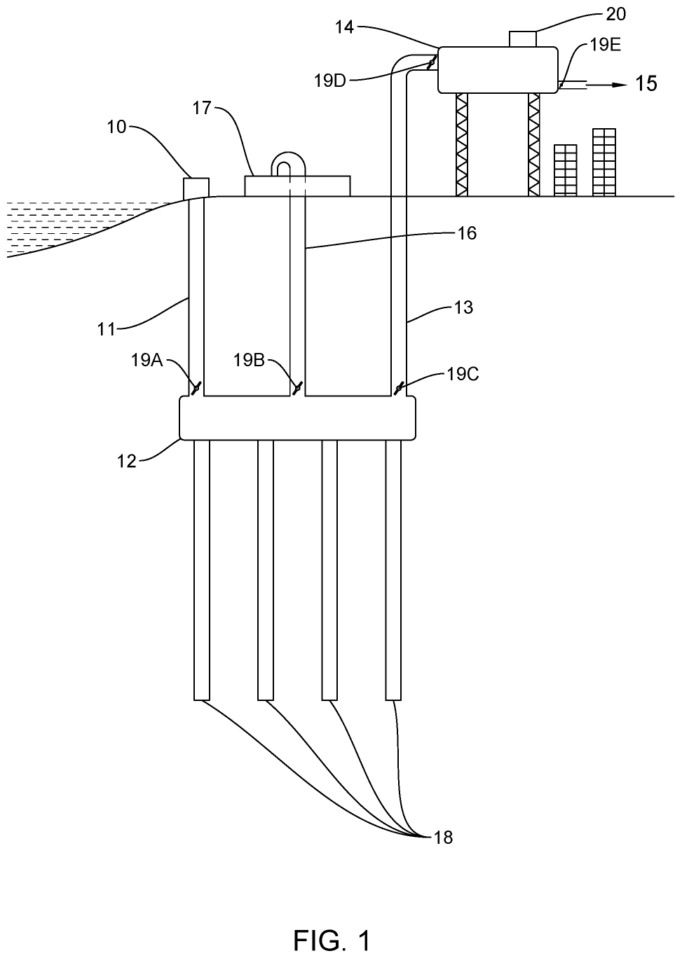

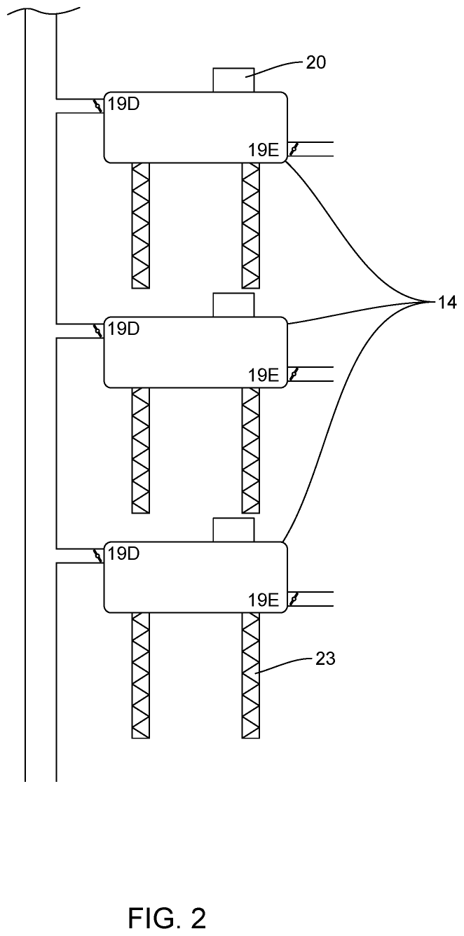

The water desalination system incorporates a number of economical and environmentally beneficial energy sources to enhance the evaporative process for greater efficiency and lower operating costs. FIGS. 1 and 2 of the drawings provide a diagrammatic representation of the water desalination system using geothermal energy.

The system and method of the present invention involve producing potable water, or drinkable, freshwater, from a brine or saltwater source.

FIG. 1 shows the overall view of geothermal based water desalination system as according to an embodiment of the present invention, wherein the system consists of a filter 21 at water injector pipe 10, wherein the filter is used to not allow seawater garbage, marine animals, and their eggs or other pollutants and sand particles to enter into a chamber 12.

The seawater enters through the seawater injector 10, the seawater injector 10 injects the filtered water through a water inlet pipe 11 into an evaporation chamber 12, wherein the evaporation chamber 12 is installed under the surface of the earth. According to an embodiment of the present invention, the water inlet pipe 11 has a valve 19A as shown in FIG. 1. The valve 19A remains open to let the water into the evaporation chamber 12. The evaporation chamber 12 is connected with a plurality of heat transfer rods 18, wherein the transfer rods 18 are installed deep earth to conduct a sufficient amount of geothermal heat to raise the temperature of the Evaporation chamber 12. The heat generated from the earth passes to heat transfer rods 18 to heat the water present into the evaporation chamber 12. With the heat transferred from heat transfer rods 18 to the evaporation chamber 12, the water present in the evaporation chamber 12 starts boiling and the boiling process results in the generation of steam, the generated steam so formed, being hot has a natural tendency to rise. The steam so generated then rises above through steam transfer pipe 13 with the opening of valve 19 c to a steam condensation and a water storage tank 14. The evaporation chamber 12 further includes a steam transfer pipe 13 on the other side of said evaporation chamber 12 which provides a way for steam to travel to steam condensation and water storage tank 14 with the opening of the valve 19. The water storage tank 14 is located at such a height that is sufficient to distribute water to the city using gravity, without any pump.

The geothermal based water desalination system as according to an embodiment of the present invention, wherein the system further comprises a brine collector tank 17 at a height above than the evaporation chamber 12, wherein the brine collector tank 17 and the evaporation chamber 12 is connected through a pipe called brine collector pipe 16. Further, the brine collector 16 serves the purpose of the collection of brine water after passing through the evaporation chamber 12.

According to another embodiment of the invention, storage tank 14 consists of a pressure system 20, the press or system 20 is present on the head of the water storage tank 14, wherein the pressure system 20 creates high pressure which forces left over brine solution to travel through brine collection pipe 16 and get deposited in brine collection tank 17, from the brine collection tank 17, the leftover brine solution is treated and discharged back to the sea.

According to another embodiment of the invention, the brine collector tank 17 further consists of one or more sensors 21, wherein sensors 21 is used to tells the user to vacate the brine collector tank 17 after being deposited by water coming out of the evaporation chamber 12 by means of the pressure system 20 on the storage tank 14. The deposited water present in the brine collector tank 17 after the heating process is discharged back to the sea, through a valve 19 F shows series tank mechanism of a water desalination system using geothermal energy as according to an embodiment of the present invention

FIG. 2 shows a series of water storage tanks 14 connected to the steam transfer pipe 13 with entry valves 19D and 19E as exit valve of the water storage tanks. The system consists of one or more series storage tanks 14 connected with the steam transfer pipe 13 at various heights to enable continuity of steam generated through evaporation chamber 12. The series of tank 14 work continuously on the amount of steam generated by the heat transfer rods 18 in the evaporation chamber 12. When one tank is filled up with steam, the valve 19D of one such tank closes and valve 19D of another tank opens to accept steam generated through evaporation chamber 12 and the process continues till the tanks present in the system get filled.

During the time taken to fill tanks with steam, the steam in the other tank gets condensed to water, thus creating space for more steam. After the tanks are filled more steam generated in the evaporation chamber 12 reaches to tanks to condense in water. This way, the present invention can continuously desalinate seawater, wherein the storage tanks 14 consist of valve 19 E which allows the freshwater to flow for useful work.

According to another embodiment of the invention, the system consists of one or more attached membranes disallowing the entry of marine animals, their eggs, and other unwanted material like plastic waste present in the oceans and seas which hinder the process of evaporation chamber 12 or cause damage to their ecosystem.

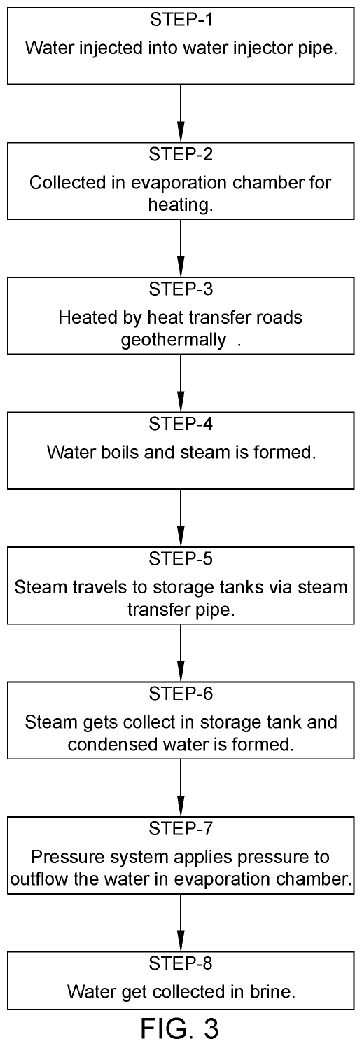

FIG. 3 shows the flow diagram of the working of the present invention. The seawater passing through filter 23, wherein filter 23 is attached to water injector 10. At step 201, The sear water is injected into an evaporation chamber through the water injector pipe 10. At step 202, collected the injected seawater by the evaporation chamber 12, wherein the seawater gets collected into chamber 12 for heating, wherein the heat is generated by a plurality of heat transfer rod 18. At step 203, the plurality of heat transfer rod 18 heated geothermally. At step 204, the heat generated from the heat transfer rods 18 boils the water, and steam is formed in the evaporation chamber, At step 205, the generated steam in the chamber is collected a water storage tank 14 via a steam transfer pipe 13. At step 206, The collected steam into the water storage tanks 14 gets condensed to form water. At step 207, a pressure system 20 applies pressure to transfer the water from evaporation chamber 12 to a brine collector tank 17. At step 208, The water transferred into the brine collector tank 17 flows out in the sea by means of valve 19 F.

It is therefore submitted that the instant invention has been shown and described in what is considered to be the most practical and preferred embodiments. It is recognized, however, that departures may be made within the scope of the invention and that obvious modification will occur to a person skilled in the art. With respect to the above description then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specification are intended to be encompassed by the present invention.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general-purpose, coupled to receive data and instructions from and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus, and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

Implementations of the embodiments may be made in hardware, firmware, software, or various combinations thereof. The embodiments may also be implemented as instructions stored on a machine-readable medium, which may be read and executed using one or more processing devices. In one implementation, machine-readable media may include various mechanisms for storing and/or transmitting information in a form that can be read by a machine (e.g., a computing device). For example, machine-readable storage media may include read-only memory, random access memory, magnetic disk storage media, optical storage media, flash memory devices, and other media for storing information, and machine-readable transmission media may include forms of propagated signals, including carrier waves, infrared signals, digital signals, and other media for transmitting the information. While firmware, software, routines, or instructions may be described in the above disclosure in terms of specific exemplary aspects and implementations performing certain actions, it will be apparent that such descriptions are merely for the sake of convenience and that such actions result from computing devices, processing devices, processors, controllers, or other devices or machines executing the firmware, software, routines, or instructions.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should, therefore, be regarded as exemplary only, with the scope of the invention determined solely by the appended claims.

While in the foregoing specification, several embodiments of the invention have been set forth for purposes of making a complete disclosure, it will be apparent to those skilled in the art that numerous changes may be made without departing from the spirit and principles of the invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### DRAWINGS—REFERENCE NUMERALS

10 Sea water Injector
11 Sea water inlet pipe
12 Evaporation chamber
13 Steam transfer pipe
14 Steam condensation and water tank
15 Filtration, Additive and Distribution Pipe
16 Brine Transfer Pipe
17 Brine collection tank
18 Heat transfer rods
19A, 19B,19C,19D & 19E 19 F Valves
20 Pressure System
21,22 Sensors
23 Filter

What is claimed is:

1. A water desalination system using geothermal energy, comprising:
a seawater injector;
an evaporation chamber configured to receive water from the water injector, wherein the chamber is held in place to an earth bottom and fixed at a depth;
a plurality of heat transfer rods extending from the evaporation chamber to a pre-defined depth to get heat geothermally;
a storage tank, to receive steam from the evaporation chamber, wherein the steam is generated in the evaporation chamber by the plurality of heat transfer rods; and
a condenser, to convert the steam into water.

2. The system as claimed in claim 1, further comprises a filter, wherein the filter is connected to the seawater injector and allows filter water to flow through the sea injector pipe.

3. The system as claimed in claim 1 further comprises a plurality of heat transfer rods held at the earth bottom which transfers heat to the evaporation chamber geothermally.

4. The system as claimed in claim 1 further comprises a plurality of pipes held at the starting and ending of pipes to connect one or more storage tanks.

5. The system as claimed in claim 1 further comprises a plurality of valves configured to allow water to flow into one or more pipes of said plurality of pipes.

6. The system as claimed in claim 1 further comprises a brine collector tank that collects the water after passing through the evaporation chamber.

7. The system as claimed in claim 1 further comprises a plurality of tanks held at the ground to collect the steam through the evaporation chamber after the heating process.

8. The system as claimed in claim 7 further comprises a pressure system in the tanks which outflow the deposited water in the evaporation chamber after the geothermal heating to the brine collector tank.

9. The system as claimed in claim 6 further comprises a sensor system that works automatically/manually to flow the deposited water into the sea after collection in the brine collector tank.
